(19) United States
(12) Patent Application Publication
(10) Pub. No.: US 2010/0121926 A1
(43) Pub. Date: May 13, 2010

(54) METHOD AND ARRANGEMENT FOR PROVIDING A RECOGNITION AWARD

(75) Inventor: Christopher J. Catalano, Hinsdale, IL (US)

Correspondence Address: DUANE MORRIS LLP - Chicago;IP DEPARTMENT, 190 South LaSalle Street, Suite 3700, CHICAGO, IL, 60603-3433, US

(73) Assignee: Mythanx LLC, Hinsdale, IL (US)

(21) Appl. No.: 12/270,747

(22) Filed: Nov. 13, 2008

(51) Int. Cl. G06F 15/16; G06Q 30/00

(52) U.S. Cl. 709/206; 705/14.39

(57) ABSTRACT

A method and apparatus to provide a recognition award, having steps of creating a computer communication to one of a group and an organization, querying a group to enter an additional message to the one of the group and the organization, compiling the additional messages from the members of the group and the computer communication into a personalized message, and sending the personalized message to the one of the group and the organization.

### BACKGROUND OF THE INVENTION

1. Field of the Invention

Aspects of an on-line recognition system are described. More specifically, aspects of an on-line method and system that allows messaging and financial appreciation submission to selected individuals are described.

2. Description of the Related Art

Receipt of gratitude is a powerful incentive to encourage activities that are beneficial to both individuals and society as a whole. Unfortunately, providing a gratuity, such as “thank you” note, is limited to conventionally known and time tested methods. Personal “thank you” messages, for example, may be accompanied by economic gifts. Such conventional methods, however, have several drawbacks that limit their use. Conventional methods require the use of conventional mail or require the individual to personally travel to provide the message to the individual. These methods of providing the gratitude require funds, such as postage, that is affixed to the “thank you” note. In the instance of a personal delivery of the note to the receiver, time is required to send the note, therefore the gratitude is not received immediately.

Failure to provide a “thank you” message immediately to a recipient may prevent the recipient from performing future acts of kindness. Positive reinforcement, however, increases the possibility of further acts of kindness. Conventional techniques fail to provide immediate feedback to the recipient without exceptional efforts expended by the person providing the recognition.

There is a need to provide a method and system to allow an individual to provide a “thank you” note or message to an individual deserving of such message.

There is a further need to provide a method and system such as that described above wherein it is easy to provide the “thank you” note or message to the deserving individual.

There is a still further need to provide a method and system to attach an economic gift to a deserving individual in addition to the message provided by the system. There is a further need to link the physical (a traditional greeting card) and digital or virtual social expressions transactions between individuals. There is a still further need to facilitate group gratitude provisions to others and to provide for storage and retrieval of historic social expressions in a single locale.

### BRIEF SUMMARY OF THE INVENTION

It is therefore an objective of an aspect of the invention to provide a method and system to provide a “thank you” note or message to an individual deserving of such message.

It is also another objective of an aspect of the invention to provide a message system and method that is easy and economical to use.

It is also another objective of an aspect of the invention to provide a method and system to attach an economic gift to a deserving individual to a personal message sent. It is a further objective on an aspect of the invention to provide a link between the physical (a traditional greeting card) and digital or virtual social expressions transactions between individuals. It is a further objective to facilitate group gratitude provisions to others and to provide for storage and retrieval of historic social expressions in a single locale.

In one aspect, a method to provide a recognition award to one of a group and an organization is presented, comprising creating a computer based communication to one of a group and an organization on a computer server; querying an additional group to enter an additional message to the communication to the one of the group and the organization, compiling the additional messages from the members of the additional group and the communication into a personalized message, and sending the personalized message to the one of the group and the organization, to an account on the server wherein the personalized message is the recognition award and wherein at least one of a physical social expression card, a greeting card and a physical object having a unique computer server access code is provided to the one of the group and the organization wherein upon entry of the unique computer access code on a computer linked to the server, the one of the group and the organization attains access to the personalized message on the server.

In another aspect, a program storage device is presented that tangibly embodies a program of instructions executable by the machine to perform method steps to provide a recognition award to one of a group and an organization having method steps of comprising creating a computer based communication to one of a group and an organization on a computer server; querying an additional group to enter an additional message to the communication to the one of the group and the organization, compiling the additional messages from the members of the additional group and the communication into a personalized message, and sending the personalized message to the one of the group and the organization, to an account on the server wherein the personalized message is the recognition award and wherein at least one of a physical social expression card, a greeting card and a physical object having a unique computer server access code is provided to the one of the group and the organization wherein upon entry of the unique computer access code on a computer linked to the server, the one of the group and the organization attains access to the personalized message on the server.

### BRIEF DESCRIPTION OF THE SEVERAL VIEWS OF THE DRAWINGS

FIG. 1 is a screen shot of a message system using the method provided in FIG. 4 in an embodiment of the invention.

FIG. 2 is a flowchart for activities for the system in accordance with another embodiment of the invention.

FIGS. 3 and 4 are portions of a method to provide a recognition award to a select individual in conformance with an aspect of the invention.

FIGS. 5 and 6 are respective front and back views of a unique social expression card.

### DETAILED DESCRIPTION OF THE INVENTION

One aspect of the invention creates an internet based global center for sending and receiving gratitude and a method of communication between entities that allows gratuities to be exchanged. This global center and associated method of communication enables the facilitation of social interactions on a one-to-one (person to person basis), one to many (person to group basis), many to one (group to individual basis), many to many (group to group) basis or from a person/group to an activity or item. Through establishment of the global center and method, individuals and groups across the globe have the ability to correspond and interact with one another. The establishment of the global center creates an on-line presence where users can create, send, and store personal messages of appreciation for a person, place, thing or activity such as on a server. In one embodiment, a user creating a “thank you” or personal message email is able to specify if the message is private or open to the public from both a viewing and participation purpose and send that message to an intended recipient.

To facilitate group appreciation from both a social interaction perspective as well as a monetary perspective, the system and method provide for the aggregation of multiple user messages and communications, media content including photos, videos etc., and monetary donations into a single message to a designated recipient. Participants are notified of the receipt of, or the participation in, the particular message via e-mail. Individuals may join or resign from groups on an as-needed basis. Groups may be of unlimited size, or may be limited by the system administrator or through group action. Groups may also have requirements in order to join the group, where a qualification process for individuals wishing to join the group is initiated when an individual attempts to join the group. As a non-limiting example, a group of medical physicians may require that members of the group have passed a qualifying state or regional standardized examination.

In another embodiment, the system and method are configured to use unique social expression cards or greeting cards that are purchased online or through various retailers. Through the use of the Internet and a physical presence in retail stores, a system and method is created that links the traditional physical world of “thank you” messages and gifts with the virtual world of messaging, storage and social utility applications. In one embodiment, a social expression card such as a prepaid cash card with a unique identifier (such as an alpha-numeric code) is purchased by an individual at a local retailer. The user may also purchase a greeting card as a stand alone unit that has a unique identifier. In another embodiment, both a greeting card or a prepaid cash card may be purchased. The social expression card, the greeting card and associated alpha-numeric code, can then be linked to a specific message on the web site. The system and method facilitate multi-user deposits into a centralized account that is linked to this unique social expression card and/or greeting card wherein a pool of funds is maintained. In one non-limiting embodiment, a financial transaction card may be used that is affiliated with a major card processing association (such as Visa or MasterCard) so that recipients of gifts via the website can purchase goods anywhere the financial transaction cards are accepted. In another embodiment, the co-branded social expression card or greeting card purchased through the retail store does not have a monetary value. The co-branded social expression card or greeting card, however, has a unique identifier that allows an individual to fill an account specified by the co-branded social expression card. The payment to the specified account can be, for example, through wire transfer of funds into the account as a non-limiting embodiment. For the greeting card embodiment, the card may have overall configuration of a conventional greeting card.

In an alternative embodiment of the method and system, a user is provided the ability to publish on-line social utility content created in the form of books and other meaningful physical forms.

In a computer based method, a computer icon is used in one embodiment to allow the user to easily access the program. The computer based icon may be configured to evolve over time based on the activity of the user (such as a tree). The icon may change over time wherein the shape of the icon indicates the level of participation in the features and functionality of the web site. In one example, the icon shape is an indication of the level of gratefulness of the user. The icon may also be configured such that it is intended to be an iconic representation of a user's developmental achievements to the use of the web site. The icon may also change with lack of participation in an alternative embodiment.

In one example, private websites may use the method of the invention to facilitate further gratuity actions of the members of a private website. In specific embodiments, the applications are private networks or additions to private networks or intranet sites to facilitate appreciation within groups.

In one embodiment, the system and method aggregates messaging and other digital media to facilitate a group message regarding an expression of appreciation or congratulations. In another embodiment, the social expression card is linked to a virtual group message and connected to a related account combined with multiple user participation and card loading capabilities.

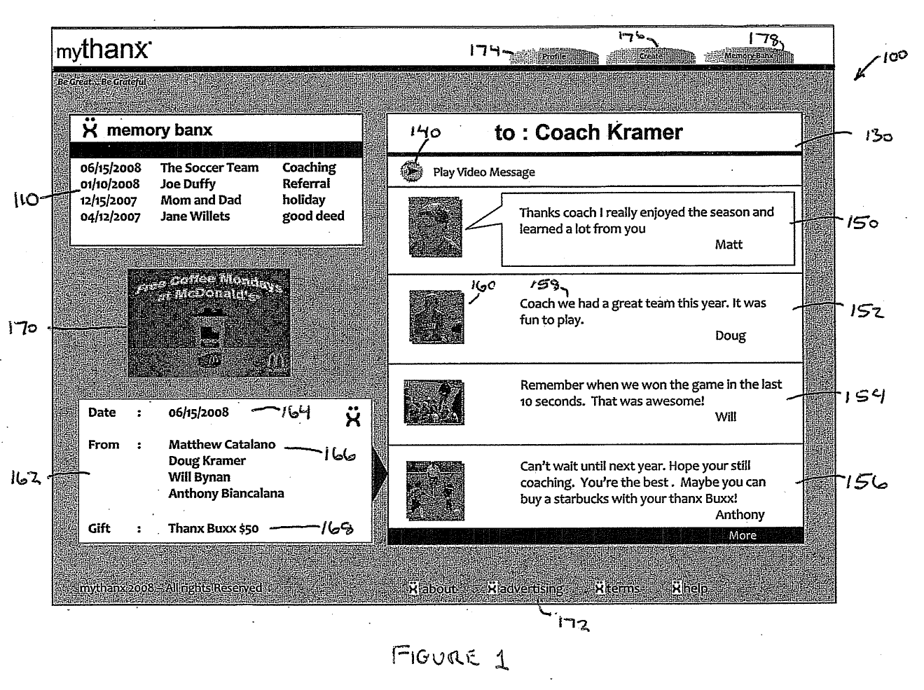

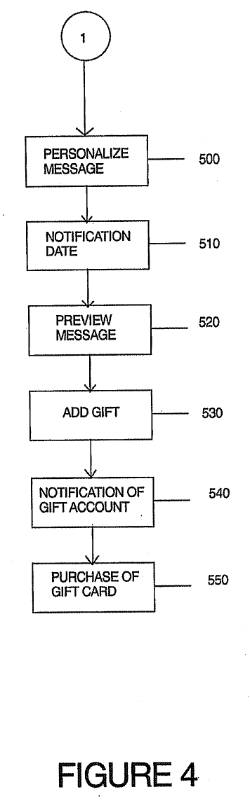

Referring to FIG. 1, a screen shot of a computer program using the method of FIG. 4 is illustrated. In the computer screen shot 100, a user may choose to review messages 110 that have been stored in a computer server. In the illustrated embodiment, four (4) messages have been saved. In the right pane section 130 of the screen shot 100, compiled messages are illustrated that relate to a specific memory bank entry 120. For the entry of “The Soccer Team”, a plurality of messages are provided for the intended recipient in the right pane 130. Attached video messages may be played by the recipient by clicking the play video message feature 140. Each of the compiled messages 150, 152, 154, 156 has an attached message 158 and video playback component 160. The messages may have video, audio only, snapshot or lack any of these features. A user may also review the profile of each of the messages. In the review message detail section 162, a date 164, the authors of the message 166 and a gift component 168 are identified. The system is further enabled to track the amount of the gift component 168 from multiple messages. An advertising portion 170 is also provided where advertisers may display a desired message. The advertising portion 170 may be hyperlinked to other advertisements, as necessary. A further advertising link 172 is provided at the bottom of the website to allow users to review associated advertising. The website further has tabs for checking a user profile 174, a message creation 176 section and the memorized messages (“memory banx”) section 178.

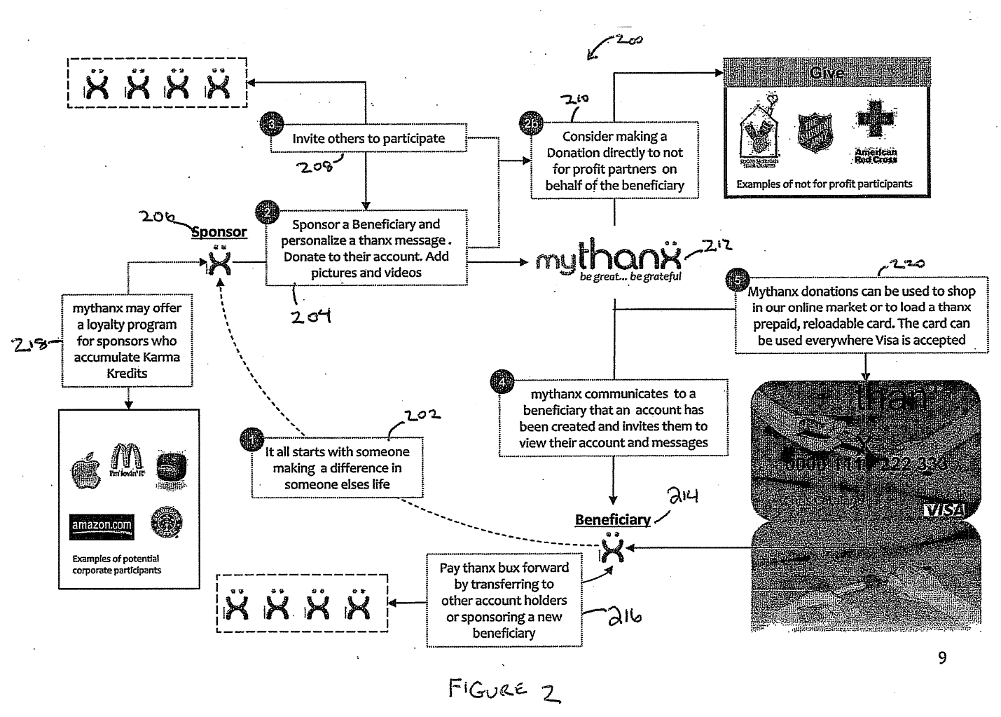

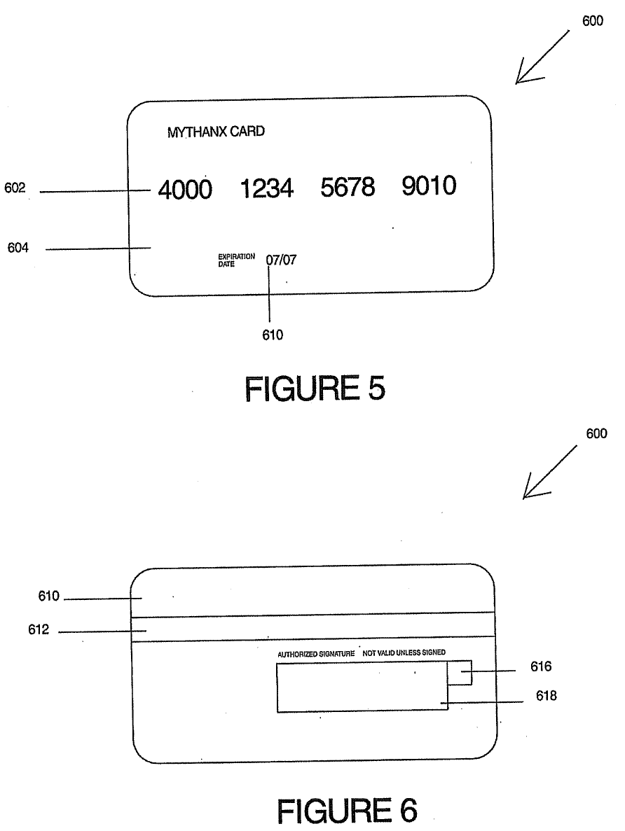

Referring to FIG. 2, a flowchart for activities in the system is presented. In the flowchart 200, an individual performs an act 202 that others believe is worthy of recognition. A personalized message, in this case an email, may be created 204 by an individual in conjunction with a sponsor 206. The sponsor may be an individual. Other individuals may be invited to participate 208 in the message. The individuals who create the message (in this case computer email), as well as potential sponsors and others invited to participate 208 may provide a donation, on the individuals behalf to a philanthropic organization 210. The website 212 then connects the sponsors (if applicable), and the personalized message created 204 to the individual who performed the act, hereinafter called the beneficiary 214, after completing a verification process to gain access to a specific account. The communication may be an email that accumulates messages from different sources, as well as video and audio clips. In one embodiment, the email message is a notification that the recipient has received a “Thanx” message viewable by logging on to a secure server. There is a link to the specific message that are contained on the “Mythanx” website. A personalized message is retained on “Mythanx” servers. The personalized message may also have a gift attached 216, such as a monetary donation made to the beneficiary through a financial transaction card or the social expression card. A loyalty program may also be included 218 where continued activity in the website may produce credits that individuals may use as designated sponsors for the loyalty program 218. Donations may be used to shop in an on-line market or to load on to a reloadable card 220, such as a co-branded social expression card, described in FIGS. 5 and 6. The sponsor may set a schedule for the email notification to be sent to the beneficiary or for others to add in their message to the server.

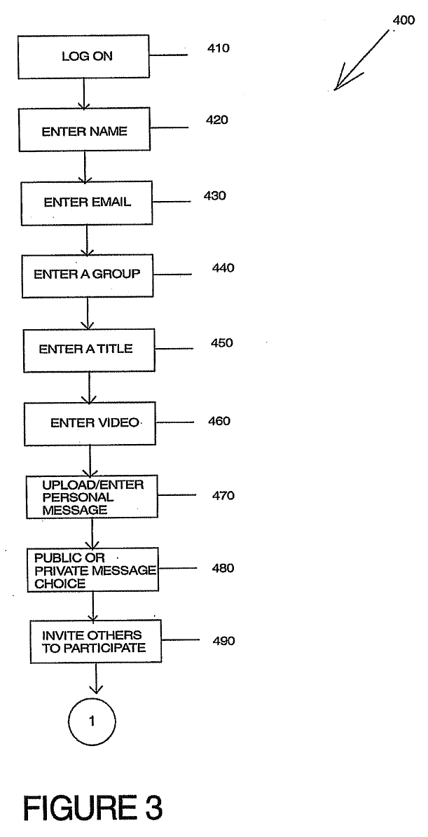

Referring to FIGS. 3 and 4, one embodiment of the invention provides for a method that starts with an individual interacting with the web site 400. A user can log on 410 and create a unique message of “thank you” for a person, place, thing or activity.

Specifically, the user will enter the name 420 and unique e-mail address 430 of a potential recipient for notification purposes. If the message is intended for multiple recipients, the user will enter a group named in multiple e-mail addresses so that all recipients can be notified 440. If the “thank you” message is directed to something as opposed to a person, and e-mail notification can be left blank.

The user then enters a title or header for the message 450. The user can also upload one unique photo or video as the title image 460. The user will then enter a personal message to the recipient 470 and they will have the ability to upload their favorite photo or video relating to the “thank you” message.

The message may then be marked as a private message or an open message 480 depending on whether the message will be open for public viewing or viewable only to select participants. The user has the ability to make the message opened to public to participation and add messages of “thank you” or participation by invitation only.

The user will then have the option of inviting other participants to add to the message by including their e-mail addresses in the provided form 490. After entering the invitation list, the user will have the ability to personalize the message that the friends will receive asking them to participate in the thank you message 500. The user will then have the ability to send a notification date 510. This is the date that the recipients will be notified that there has been a “thank you” message created in their name.

The user is then able to select “preview” to view the message 520. A gift may be added to the message 530, if required by the user. If “add a gift” is selected, the user has the ability to set a target of funds to achieve and load money into the recipients account via several payment options. When individuals that were previously invited in the previous step receive their invitation to participate, they will be notified that there has been a gift account set up and they will be asked if they would like to contribute to the account 540. A user is able to order a social expression card or greeting card online or purchase one at a local retail store 550. These social expression/greeting cards have a unique code that will be entered when a “thank you” gift account is created. In an alternative embodiment, an object, such as a stuffed animal, may have the unique code. When the recipient is given the “thank you” card either social expression or greeting card, they will be able to activate the associated monetary account for use on-line when they view their “thank you” email message. The social expression card or greeting card may be funded by transferring money to the uniquely coded account specified by the card, by, for example, by credit card.

A user profile is established for each registered user. A user profile includes data such as name, e-mail address, password, location, data field for entering what they are thankful for as non-limiting examples. The user profile are stored on a computer server and may be easily recalled when a user opens an entry program through an icon. The profile icon is created that will grow/modify over time based on the user's interaction with the web site. The icon is intended to represent the expansion of the user's gratefulness.

All of the messages are stored in the system, such as a computer server, so that they can be previewed whenever a user wishes. Additionally, a registered user will have the ability to publish the content created in their name. The system also enables the production of books or other physical media with the user generated content, as needed.

In an alternative embodiment, a user may load money into a recipients account but not include a gift card. This may be performed through use of a conventional financial transaction card. The user may telephonically transfer funds from the conventional transaction card into an account provided by the system such that a desired amount is deposited within the pre-made account. The account may be configured such that a person may identify the amount of money/resources a person placed within the account or, in an alternative embodiment, the amount of money in the account may not be itemized.

Referring to FIGS. 5 and 6, a social expression card 600 is illustrated. The social expression card 600 is configured with a unique identifier number 602 on the front face 604 to clearly identify an account into which funds may be submitted. The social expression card 600 has a front face upon which the unique identifier number 602 is placed. The social expression card 600 may also be configured with an expiration date 610, if necessary.

The back face 610 of the social expression card 600 is optionally configured with a card strip 612 that is a conventional magnetic stripe unit. The back face 610 of the social expression card 600 may additionally be optionally configured with a signature block for identification purposes. A security code 616 may also be provided such that an additional check is provided for identification purposes when the social expression card 600 is used. The social expression card 600 may also be configured with a signature block 618 that allows identification of the individual bearing the card.

In another embodiment a card, such as a greeting card may be provided instead of a social greeting card 600 previously described. The greeting card has a unique code printed on the card to allow a user to log onto the website. The greeting card may be purchased at a participating retailer. The website would launch, for example, a specific “Mythanx” message. In an alternative configuration, a recipient may allocate all or a portion of funds received by the system to prepaid gift cards.

In the foregoing specification, the aspects of the invention have been described with reference to specific embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. A method to provide a recognition award, comprising:
creating a computer based communication to one of a group and an organization on a computer server;
querying an additional group to enter an additional message to the communication to the one of the group and the organization;
compiling the additional messages from the members of the additional group and the communication into a personalized message; and
sending the personalized message to the one of the group and the organization, to an account on the server wherein the personalized message is the recognition award and wherein at least one of a physical social expression card, a greeting card and a physical object having a unique computer server access code is provided to the one of the group and the organization wherein upon entry of the unique computer access code on a computer linked to the server, the one of the group and the organization attains access to the personalized message on the server.

2. The method according to claim 1, wherein the personalized message is stored on a server with a dynamic memory.

3. The method according to claim 1, wherein the physical social expression card contains an economic gift.

4. The method according to claim 1, wherein one of the personalized message, the communication and the additional messages is a personalized computer email.

5. The method according to claim 1, wherein one of the personalized message, the communication and the additional messages has a video component.

6. The method according to claim 1, wherein the one of the personalized message, the communication and the additional messages has an audio component.

7. The method according to claim 4, wherein the social expression card is an economic gift to accompany the at least one of the communication, the additional message to the one of the group and the organization and the personalized message, wherein the economic gift is obtained from a pool of funds.

8. The method according to claim 5, wherein the social expression card is an economic gift to accompany the at least one of the communication, the additional message to the one of the group and the organization and the personalized message.

9. The method according to claim 6, wherein the social expression card is an economic gift to accompany the at least one of the computer communication, the additional message to the one of the group and the organization and the personalized message.

10. A program storage device readable by machine, tangibly embodying a program of instructions executable by the machine to provide a recognition award, comprising:
creating a computer based communication to one of a group and an organization on a computer server;
querying an additional group to enter an additional message to the communication to the one of the group and the organization;
compiling the additional messages from the members of the additional group and the communication into a personalized message; and
sending the personalized message to the one of the group and the organization, to an account on the server wherein the personalized message is the recognition award and wherein at least one of a physical social expression card, a greeting card and a physical object having a unique computer server access code is provided to the one of the group and the organization wherein upon entry of the unique computer access code on a computer linked to the server, the one of the group and the organization attains access to the personalized message on the server.

11. The program storage device according to claim 10, wherein the communication is stored on a server.

12. The program storage device according to claim 10, wherein the method accomplished further comprises:
attaching an economic gift to at least one of the computer communication, the additional message to the one of the group and the organization and the personalized message.

13. The program storage device according to claim 10, wherein one of the personalized message, the computer communication and the additional messages is a personalized computer email.

14. The program storage device according to claim 10, wherein the one of the personalized message, the computer communication and the additional messages has a video component.

15. The program storage device according to claim 10, wherein the one of the personalized message, the computer communication and the additional messages has an audio component.

16. The program storage device according to claim 13, wherein the method accomplished further comprises:
attaching an economic gift to at least one of the computer communication, the additional message to the one of the group and the organization and the personalized message.

17. The program storage device according to claim 14, wherein the method accomplished further comprises:
attaching an economic gift to at least one of the computer communication, the additional message to the one of the group and the organization and the personalized message.

18. The program storage device according to claim 15, wherein the method accomplished further comprises:
attaching an economic gift to at least one of the computer communication, the additional message to the one of the group and the organization and the personalized message.
